(19) United States
(12) Patent Application Publication
(10) Pub. No.: US 2026/0064461 A1
(43) Pub. Date: Mar. 5, 2026

(54) METHOD, DEVICE, AND COMPUTER PROGRAM PRODUCT FOR DETERMINING JOB CONFLICTS

(71) Applicant: DELL PRODUCTS L.P., ROUND ROCK, TX (US)

(72) Inventors: Xiaolei HU, Shanghai (CN); Yudai WANG, Shanghai (CN); Yuanzhuo YU, Shanghai (CN); Zheyi ZHU, Shanghai (CN); Jing YU, Shanghai (CN)

(21) Appl. No.: 18/923,013

(22) Filed: Oct. 22, 2024

(30) Foreign Application Priority Data
Sep. 3, 2024 (CN) 202411233795.0

(51) Int. Cl. G06F 9/48

(52) U.S. Cl. CPC G06F 9/4881

(57) ABSTRACT

Embodiments of the present disclosure relate to a method, a device, and a computer program product for determining job conflicts. The method includes determining, based on a job type of a target job, a target vertex corresponding to the target job in a dynamic graph. The method also includes generating, based on conflict strategies identified by a static graph, a target edge associated with the target vertex in the dynamic graph. In addition, the method also includes determining, in response to the target edge already existing in the dynamic graph, that a conflict exists between the target job and a running job.

### TECHNICAL FIELD

Embodiments of the present disclosure relate to the field of computers, and in particular to a method, an apparatus, a device, and a computer program product for determining job conflicts.

### BACKGROUND

With the acceleration of informatization process and the rapid growth of data volume, data has become an important asset of enterprises and organizations, and the role of data protection systems has become increasingly critical. A data protection system can provide a variety of functions such as backup, recovery, and replication, effectively preventing data risks and ensuring service continuity, thus becoming an important means of guarantee in the information age.

With the complexity of data protection systems and the diversification of job types, the importance of conflict management in the system is increasingly prominent. Conflicts between different jobs may lead to data loss, service interruption, or wasted resources, severely impacting system reliability and efficiency. Therefore, establishing an effective conflict management mechanism to ensure the compatibility and coordination between jobs has become a critical task of the data protection system.

### SUMMARY OF THE INVENTION

Embodiments of the present disclosure provide a method, a device, and a computer program product for determining job conflicts.

According to an aspect of the present disclosure, a method for determining a job conflict is provided. The method includes determining, based on a job type of a target job, a target vertex corresponding to the target job in a dynamic graph, wherein the target job is associated with an operation in a data protection system, and the dynamic graph is generated based on a static graph identifying conflict strategies between different job types. The method further includes generating, based on the conflict strategies identified by the static graph, a target edge associated with the target vertex in the dynamic graph, wherein an edge in the dynamic graph corresponds to a running job in the data protection system. The method further includes determining, in response to the target edge already existing in the dynamic graph, that a conflict exists between the target job and the running job.

According to another aspect of the present disclosure, an electronic device is provided. The device includes a processing unit and a memory, wherein the memory is coupled to the processing unit and has instructions stored therein. The instructions, when executed by the processing unit, perform the following actions: determining, based on a job type of a target job, a target vertex corresponding to the target job in a dynamic graph, wherein the target job is associated with an operation in a data protection system, and the dynamic graph is generated based on a static graph identifying conflict strategies between different job types; generating, based on the conflict strategies identified by the static graph, a target edge associated with the target vertex in the dynamic graph, wherein an edge in the dynamic graph corresponds to a running job in the data protection system; and determining, in response to the target edge already existing in the dynamic graph, that a conflict exists between the target job and the running job.

According to still another aspect of the present disclosure, a computer program product is provided. The computer program product is tangibly stored in a non-transitory computer-readable medium and includes computer-executable instructions. The computer-executable instructions, when executed, cause a computer to perform the method or process according to the embodiments of the present disclosure.

The Summary of the Invention section is provided to introduce the selection of concepts in a simplified form, which will be further described in the Detailed Description below. The Summary of the Invention section is neither intended to identify key features or essential features of the present disclosure, nor intended to limit the scope of the embodiments of the present disclosure.

### BRIEF DESCRIPTION OF THE DRAWINGS

By describing the illustrative embodiments of the present disclosure in more detail with reference to the accompanying drawings, the above and other objectives, features, and advantages of the present disclosure will become more apparent. In the example embodiments of the present disclosure, the same reference numerals generally represent the same elements.

FIG. 1 shows a schematic diagram of an example environment in which a device and/or method according to embodiments of the present disclosure can be implemented;

FIG. 2 shows a flow chart of a method for determining job conflicts according to an embodiment of the present disclosure;

FIG. 3A shows a schematic diagram of an example static directed multigraph according to an embodiment of the present disclosure;

FIG. 3B shows a schematic diagram of another example static directed multigraph according to an embodiment of the present disclosure;

FIG. 4A illustrates a schematic diagram of a process 400A using a dynamic directed multigraph according to an embodiment of the present disclosure;

FIG. 4B shows a schematic diagram of a process of conflict detection using a dynamic directed multigraph according to an embodiment of the present disclosure;

FIG. 4C shows a schematic diagram of another process of conflict checking using a dynamic directed multigraph according to an embodiment of the present disclosure;

FIG. 5 shows a schematic diagram of a process of conflict checking according to an embodiment of the present disclosure;

FIG. 6 shows a schematic diagram of a process of job management in a data protection system according to an embodiment of the present disclosure;

FIG. 7A shows a schematic diagram of a process of collecting data to train a Graph Neural Network (GNN) according to an embodiment of the present disclosure;

FIG. 7B shows a schematic diagram of a flow of generating a conflict strategy based on a GNN and performing verification according to an embodiment of the present disclosure;

FIG. 8 shows a schematic block diagram of a device that can be used to implement the embodiments of the present disclosure.

In the various accompanying drawings, identical or corresponding reference numerals represent identical or corresponding parts.

### DETAILED DESCRIPTION

Preferred embodiments of the present disclosure will be described in further detail below with reference to the accompanying drawings. While some specific embodiments of the present disclosure are shown in the accompanying drawings, it should be understood that the present disclosure may be implemented in various forms, and should not be limited to the embodiments set forth herein. Rather, these embodiments are provided to make the present disclosure more thorough and complete and to fully convey the scope of the present disclosure to those skilled in the art.

The term “including” and variants thereof used herein indicate open-ended inclusion, that is, “including but not limited to.” Unless specifically stated, the term “or” indicates “and/or.” The term “based on” indicates “based at least in part on.” The terms “an example embodiment” and “an embodiment” indicate “at least one example embodiment.” The term “another embodiment” indicates “at least one additional embodiment.” The terms “first,” “second,” and the like may refer to different or identical objects, unless otherwise specifically indicated.

In a data protection system, many operations are considered as jobs, such as backup jobs, recovery jobs, and replication jobs. Since potential conflicts between different jobs may prevent the jobs from running at the same time, it is especially important to detect such conflicts. In the prior art, a data protection system usually stores the information on all running jobs in a cache, and each time a new job is introduced, all the jobs in the cache are searched for and compared one by one to detect conflicts. Such method has a high time complexity, and as the number of jobs increases, the system needs to perform a large number of searches and comparison operations, resulting in a significant decrease in the efficiency of conflict detection.

To this end, embodiments of the present disclosure propose a scheme for determining job conflicts. This scheme introduces a static graph that identifies conflict strategies between different job types, and models the process of job conflict detection as a dynamic graph processing task, thereby providing an efficient job conflict management mechanism. Specifically, a corresponding target vertex is first determined in the static graph according to a job type of a target job. Then, a target edge associated with the target vertex is generated according to conflict strategies identified by the static graph. Finally, by detecting the generated target edge, it is determined whether the target job conflicts with a running job.

Accordingly, according to the scheme of the embodiments of the present disclosure, by modeling the job conflict detection as a dynamic graph task and generating corresponding edges in the dynamic graph according to the static graph, the job conflict detection is converted into detection of edges in the dynamic graph, avoiding searching for and comparing all jobs in the cache one by one, which can reduce the time complexity of conflict detection, thereby improving the operation efficiency of the data protection system.

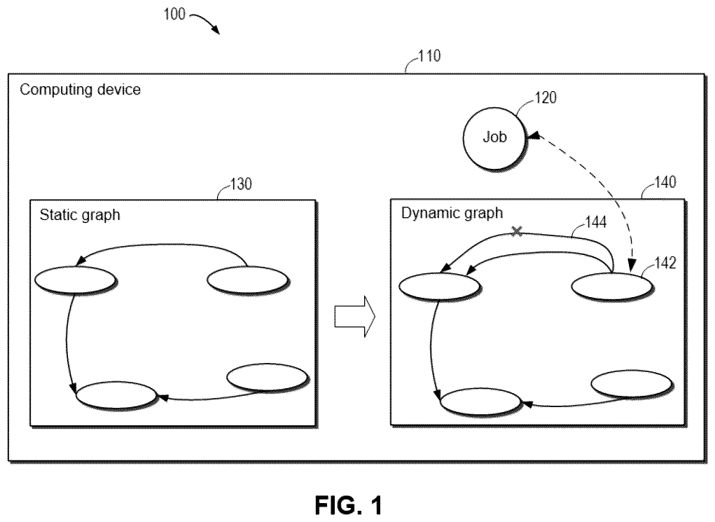

The basic principles and several example implementations of the present disclosure will be described below with reference to FIG. 1 to FIG. 8. It should be understood that these illustrative embodiments are given only to enable those skilled in the art to better understand and thus implement the embodiments of the present disclosure, and are not intended to limit the scope of the present disclosure in any way.

FIG. 1 shows an example environment 100 in which a device and/or method according to embodiments of the present disclosure can be implemented. As shown in FIG. 1, the example environment 100 may include a computing device 110, which may be a user terminal, a mobile device, a computer, or the like, and may also be a computing system, a single server, a distributed server, or a cloud-based server. The computing device 110 may be deployed in a data protection system or can also be deployed in a cloud and connected with a data protection system via a network, and embodiments of the present disclosure do not limit this. A target job 120 may be a new job to enter the data protection system. As mentioned earlier, in a data protection system, many operations are considered as jobs, such as backup jobs, recovery jobs, and replication jobs. The computing device 110 may determine a target vertex 142 corresponding to the target job 120 in a dynamic graph 140 according to the job type of the target job 120. The dynamic graph 140 may be generated based on a static graph 130, which may also be referred to as initialization. For example, the dynamic graph 140 may be initialized based on the static graph 130 when the data protection system starts running. The initialized dynamic graph 140 has the same vertexes as the static graph 130, but does not have edge connections.

Each vertex in the static graph 130 corresponds to a different type of job. In other words, the number of job types in the data protection system is the same as the number of vertexes in the static graph 130 and correspondingly the same as the number of vertexes in the dynamic graph 140. For example, the target job 120 has a job type of backup job, and the target vertex 142 corresponds to a backup job, so the target job 120 corresponds to the target vertex 142. Furthermore, each edge between vertexes in the static graph 130 may indicate a conflict strategy between the corresponding job types. For example, the conflict strategy may be that if a job type A is running, a job type B will not be able to start, and this conflict strategy may be represented as an edge in the static graph 130. The static graph 130 defines predetermined job types and their conflict strategies, and these strategies do not change dynamically during the operation of the data protection system, so it is called a static graph.

A target edge 144 associated with the target vertex 142 may then be generated in the dynamic graph 140 according to a conflict strategy identified by the static graph 130. For example, the conflict strategy is represented by an edge in the static graph 130, then a corresponding edge may be generated in the dynamic graph 140 based on the edge in the static graph 130. Furthermore, each edge in the dynamic graph 140 corresponds to each running job in the data protection system. For example, if there are ten edges, ten jobs are running in the data protection system. Furthermore, since the generated target edge 144 already exists in the dynamic graph 140, it can be determined that a conflict exists between the target job 120 and a running job.

Accordingly, by modeling the job conflict detection as a dynamic graph task and generating corresponding edges in the dynamic graph according to the static graph, the job conflict detection is converted into detection of edges in the dynamic graph, avoiding searching for and comparing all jobs in the cache one by one, thereby reducing the time complexity of conflict detection and improving the operation efficiency of the data protection system.

It should be understood that the architecture and function in the example environment 100 are described merely for illustration purposes, and do not imply any limitation to the scope of the present disclosure. The embodiments of the present disclosure may also be applied to other environments having different structures and/or functions.

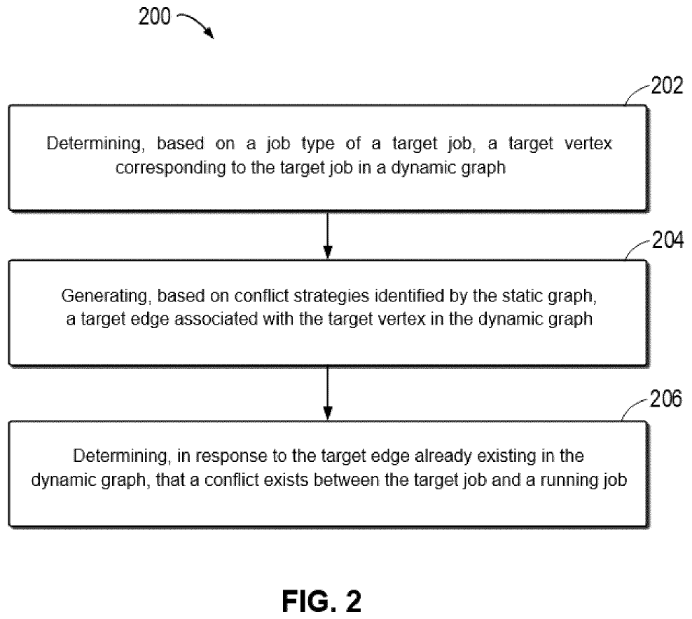

A process according to embodiments of the present disclosure will be described in detail below with reference to FIG. 2 to FIG. 8. For ease of understanding, the specific data mentioned in the following description are all illustrative and are not to limit the scope of protection of the present disclosure. It should be understood that the embodiments described below may also include additional actions not shown and/or may omit actions shown, and the scope of the present disclosure is not limited in this regard.

FIG. 2 shows a flow chart of a method 200 for determining job conflicts according to an embodiment of the present disclosure. At block 202, a target vertex corresponding to a target job may be determined in a dynamic graph based on a job type of the target job, wherein the target job is associated with an operation in a data protection system, and the dynamic graph is generated based on a static graph identifying conflict strategies between different job types. For example, described in conjunction with FIG. 1, the computing device 110 may determine in the dynamic graph 140 a target vertex 142 corresponding to the target job 120 based on the job type of the target job 120, the target job 120 is associated with an operation in the data protection system, and the dynamic graph 140 is generated based on the static graph 130 which identifies conflict strategies between different job types.

At block 204, a target edge associated with the target vertex may be generated in the dynamic graph based on the conflict strategies identified by the static graph, wherein edges in the dynamic graph correspond to running jobs in the data protection system. For example, described in conjunction with FIG. 1, the computing device 110 may generate, in the dynamic graph 140, a target edge 144 associated with the target vertex 142 based on a conflict strategy identified by the static graph 130, wherein edges in the dynamic graph 140 correspond to running jobs in the data protection system.

At block 206, it may be determined that a conflict exists between the target job and a running job in response to the target edge already existing in the dynamic graph. For example, described in conjunction with FIG. 1, the computing device 110 may determine, in response to the target edge 144 already existing in the dynamic graph 140, that a conflict exists between the target job 120 and a running job.

Accordingly, according to the method 200 of the embodiments of the present disclosure, by modeling the job conflict detection as a dynamic graph task and generating corresponding edges in the dynamic graph according to the static graph, the job conflict detection is converted into detection of edges in the dynamic graph, avoiding searching for and comparing all jobs in the cache one by one, which can reduce the time complexity of conflict detection, thereby improving the operation efficiency of the data protection system.

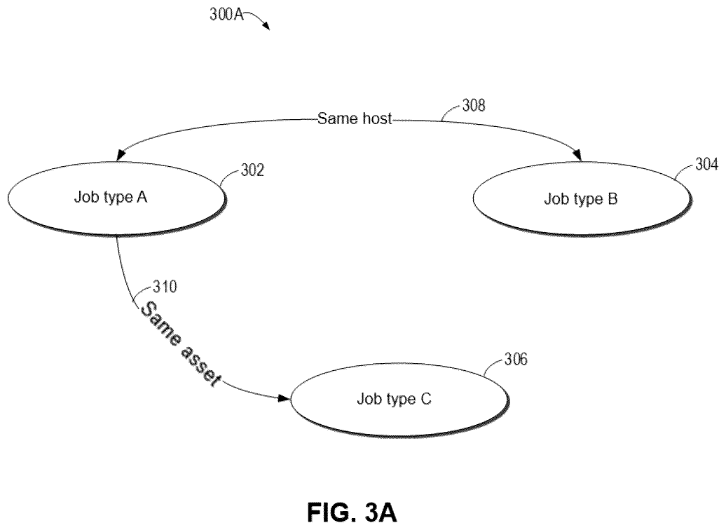

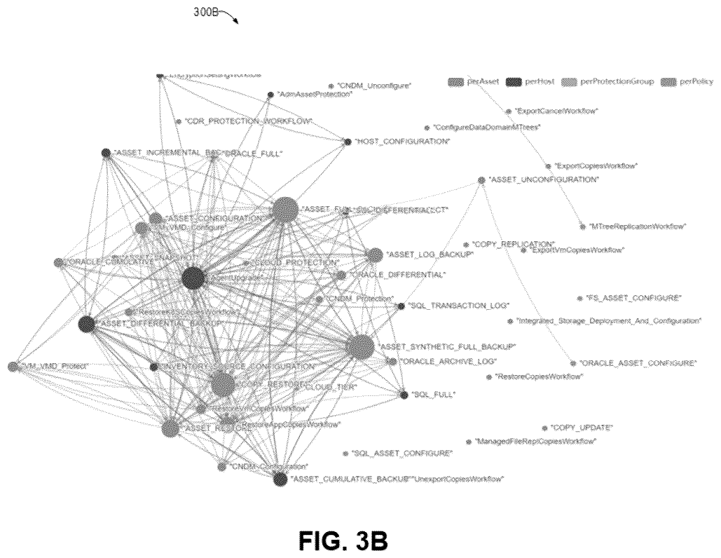

FIG. 3A shows a schematic diagram of an example static directed multigraph 300A according to an embodiment of the present disclosure. A directed multigraph is a graph structure in which there may be multiple edges with definite directions between vertexes, and each edge has a starting point and an end point that represent a directed connection from a vertex to another vertex. In addition, a directed multigraph allows multiple edges to exist between the same pair of vertexes, and each of the edges can represent a different relationship or condition. Such structure is suitable for representing complex dependencies. For example, in job conflict detection, a static directed multigraph can represent conflict relationships between different job types. As shown in FIG. 3A, the static directed multigraph may include a vertex 302, a vertex 304, and a vertex 306, and edges 308 and 310.

In the descriptions of some embodiments of the present disclosure, vertex is a concept in a graph model which represents a job type, and a vertex and a job type correspond to each other. For example, the vertex 302 corresponds to a job type A, the vertex 304 corresponds to a job type B, and the vertex 306 corresponds to a job type C. Job type refers to a kind of jobs that have specific attribute characteristics. For example, a backup job and a recovery job can be considered as different job types. Job refers to a specific job instance that belongs to a particular job type. For example, a backup operation for specific data can be considered as an instance of backup-type jobs. Edge is a concept in a graph model that is a connection between two vertexes and is used to represent a conflicting relationship between different job types, also known as a conflict strategy.

The edge 308 may indicate that there is a conflict between the job type A and the job type B, and the condition of the conflict strategy can be that if the two job types use the same host, a conflict will occur between them. In addition, the edge 308 is bidirectional, indicating that the conflict relationship is also bidirectional, that is, if the job type A is running, the job type B will not be able to start; and vice versa, if the job type B is running, the job type A cannot start either. Hosts can include physical or virtual servers or hosts that perform jobs. Furthermore, in some embodiments of the present disclosure, bidirectional edges may be regarded as two unidirectional edges in opposite directions. For example, the edge 308, as a bidirectional edge, can be regarded as an edge from the vertex 302 to the vertex 304 and an edge from the vertex 304 to the vertex 302.

The edge 310 may indicate that there is a conflict between the job type A and the job type C, and the condition of the conflict strategy can be that if the two job types involve the same asset, then the job type A cannot start while the job type C is running. However, the job type C can start while the job type A is running. This conflict is unidirectional, i.e., the job type A is limited by the job type C, while the job type C is not affected by the job type A. Assets can represent specific data resources (such as files, databases, and so on) for job processing. In addition, different jobs can use the same machine or asset, or can use different hosts or assets, and the hosts and/or assets used by the jobs can be referred to as the attributes of the jobs. FIG. 3A shows an example of a static directed multigraph used to represent conflicting relationships, and it should be understood that conflicting relationships between different job types may be very complicated in practice application.

FIG. 3B shows a schematic diagram of another example static directed multigraph according to an embodiment of the present disclosure. In some embodiments, a YAML file may be used to manage conflict strategies in a static directed multigraph. For example, a YAML file can describe conflicting relationships between different job types and their dependencies, and visually express these relationships through vertexes and edges in the graph structure. By modeling the conflict relationships between different job types as vertexes and edges in a graph structure, the static directed multigraph provides a basis for the subsequent conflict detection using a dynamic directed multigraph. In addition, the static directed multigraph has a high degree of flexibility and scalability, which can adapt to the adjustment between different job types, and facilitate the addition, deletion, or modification of conflict strategies to meet complex service demands.

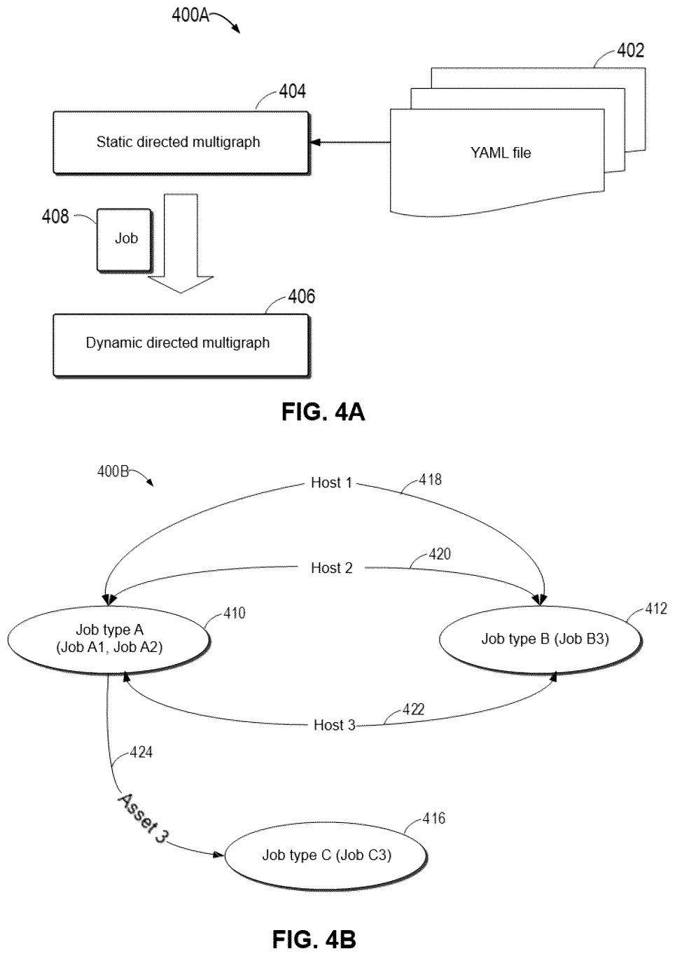

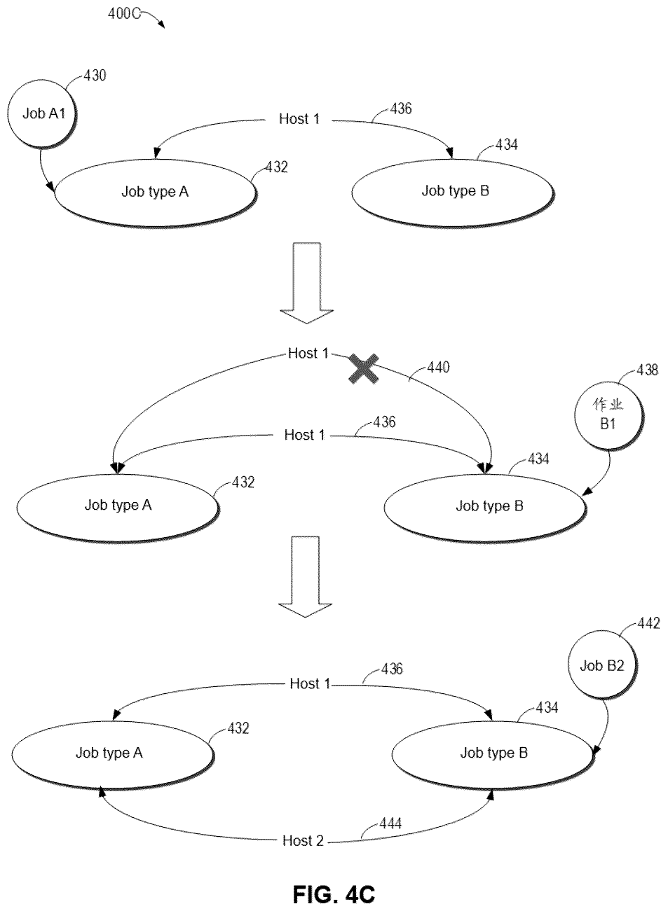

FIG. 4A illustrates a schematic diagram of a process 400A using a dynamic directed multigraph according to an embodiment of the present disclosure. On the basis of the static directed multigraph, when a new job arrives, a dynamic directed multigraph can be built in an actual environment. The static directed multigraph model is mainly used to manage and define static conflict strategies between jobs, and the dynamic directed multigraph is generated at runtime to detect whether there is a conflict between the new job and a currently running job. As shown in FIG. 4, as shown in FIG. 4, the static directed multigraph 404 may be generated through a YAML file 402, where a plurality of job types and conflict strategies between them are defined in the YAML file 402. For example, the conflict strategy for the job type A and the job type B can be defined as generating a conflict when they use the same host.

When a new job enters the data protection system, if the dynamic directed multigraph has not yet been created, the system can first initialize and create the dynamic directed multigraph, which means that there is no job running in the current system, so the new job will not cause a conflict. For example, a dynamic directed multigraph may be created by utilizing a preset rule in the static directed multigraph 404 to map each job type to a corresponding vertex. It should be understood that the newly created dynamic directed multigraph has the same vertexes as the static directed multigraph, but does not contain any edge connection in the initial state. If a dynamic directed multigraph has been created, the dynamic directed multigraph can be directly used for conflict detection. For example, with the arrival of the job 408, edges associated with the job 408 may be dynamically generated based on the conflict strategies defined in the static directed multigraph 404. Then, it is determined whether the job 408 conflicts with running jobs by checking whether such edges already exist in the dynamic directed multigraph 406.

FIG. 4B shows a schematic diagram of a process 400B of conflict detection using a dynamic directed multigraph according to an embodiment of the present disclosure. As shown in FIG. 4B, when a job A1 and a job A2 (as illustrated at the vertex 410) enter the data protection system, corresponding edges may be generated according to the conflict strategies in the static directed multigraph (e.g., the static directed multigraph shown in FIG. 3A). For example, the job A1 uses a host 1 (also known as the attribute of the job A1 being host 1), and the job A2 uses a host 2. Thus, when the job A1 enters the system, an edge 418 between the vertex 410 (corresponding to the job type A) and a vertex 412 (corresponding to the job type B) may be generated, and an edge attribute of the edge 418 is the host 1 (i.e., the attribute of the job A1). When the job A2 enters the system, an edge 420 between the vertex 410 and the vertex 412 may be generated, and the edge attribute of the edge 420 is host 2 (i.e., the attribute of the job A2).

When a job B3 (using a host 3) enters the system, an edge 422 between the vertex 410 and the vertex 412 may be generated, and the edge attribute of the edge 422 is host 3 (i.e., the attribute of the job B3). As described previously in FIG. 3A, the conflict strategy between the job type A and the job type B is that if the two job types use the same host, a conflict will occur between them. Since the jobs A1, A2, and B3 each use a different host, there is no conflict between them. In the dynamic directed multigraph, edges 418, 420, and 422 are different edges, which means that there is no conflict between the corresponding jobs. In addition, when a job C3 (as illustrated at a vertex 416) enters the system, an edge 424 between the vertex 410 and the vertex 416 may be generated. Similarly, since there is no edge the same as the edge 424 in the dynamic directed multigraph (i.e., no edge with a starting point being the vertex 410, an end point being the vertex 416, and an edge attribute being the asset 3), the job C3 does not conflict with any existing jobs. With these steps, the dynamic directed multigraph can be continuously updated to reflect the jobs and resource usage in the current system. FIG. 4B shows the scenario where no conflict is detected, and the scenario where a conflict is detected will be described below in conjunction with FIG. 4C.

FIG. 4C shows a schematic diagram of another process 400C of conflict checking using a dynamic directed multigraph according to an embodiment of the present disclosure. First, the static directed multigraph (not shown) corresponding to the dynamic directed multigraph in FIG. 4C defines two vertexes, “job type A” and “job type B,” and defines two conflict strategies, namely, “Rule-AB-1” and “Rule-AB-2,” where “Rule-AB-1” is to generate edges based on host IDs and “Rule-AB-2” is to generate edges based on asset IDs. Referring to FIG. 4C, when a job 430 enters the system, an attribute of the job 430 may be obtained. For example, the attribute of the job 430 may be asset 1 and host 1, that is, the job 430 may use a data asset corresponding to the asset 1 and execute on the host 1. A job type of the job 430 may then be obtained, and a corresponding vertex may be determined according to the job type. For example, the job 430 belongs to the job type A, thereby determining that the job 430 corresponds to a vertex 432. Then, a new edge can be generated in the dynamic directed multigraph based on the conflict strategies defined in the static directed multigraph. For example, an edge 436 can be generated between a vertex 432 and a vertex 434 in a dynamic directed multigraph to update the dynamic directed multigraph.

When a job 438 enters the system, an attribute of the job 438 may be obtained. For example, the attribute of the job 438 may include asset 2 and the host 1, that is, the job 438 may use a data asset corresponding to the asset 2 and execute on the host 1. A job type of the job 430 may then be obtained, and a corresponding vertex may be determined according to the job type. For example, the job 438 belongs to job type B, thereby determining that the job 438 corresponds to the vertex 434. Then, a new edge can be generated in the dynamic directed multigraph based on the conflict strategies defined in the static directed multigraph. For example, an edge 440 may be generated between the vertex 432 and the vertex 434 in a dynamic directed multigraph. The dynamic directed multigraph can be checked, and it is found that the same edge 436 as the edge 440 already exists, indicating that there is a conflict between the job 438 and the job 430. For example, if the starting points and the end points of the edges and the edge attributes are the same, it can be determined that the two edges are the same. For example, as the edge 436 and the edge 440 are both bidirectional edges having the host 1, it is determined that they are the same. When determining that a conflict exists, running the job 438 may be abandoned to avoid a risk of resource contention or system instability.

When a job 442 enters the system, an attribute of the job 442 may be obtained. For example, the attribute of the job 438 may include asset 3 and host 2, i.e., the job 442 may use a data asset corresponding to the asset 2 and be executed on the host 2. A job type of the job 442 may then be obtained, and a corresponding vertex may be determined in the dynamic directed multigraph according to the job type. For example, the job 442 belongs to a job type B, thereby determining that the job 442 corresponds to the vertex 434. Then, a new edge can be generated in the dynamic directed multigraph based on the conflict strategies defined in the static directed multigraph. For example, an edge 444 may be generated between the vertex 432 and the vertex 434 in a dynamic directed multigraph. The dynamic directed multigraph may be checked, and it is found that no edge the same as the edge 444 exists, indicating that there is no conflict between the job 442 and the running jobs, so the job 442 may be executed, and the edge 444 may be added to the dynamic directed multigraph.

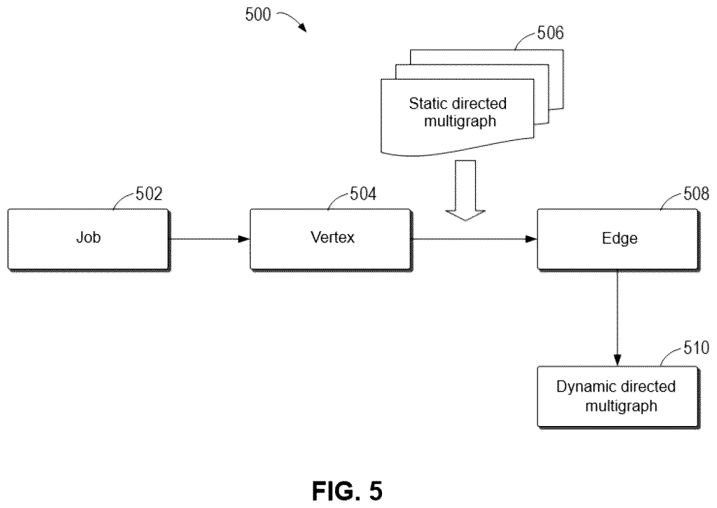

FIG. 5 shows a schematic diagram of a process 500 of conflict checking according to an embodiment of the present disclosure. As shown in FIG. 5, when a new job 502 arrives, a vertex 504 corresponding to the new job 502 may be searched for. In some embodiments, a vertex search may be implemented by means of a vertex hash table. For example, the key in the vertex hash table is the job type, and the value in the vertex hash table is the corresponding vertex, so the time complexity of the vertex search operation is O(1), that is, the search time is fixed no matter how many jobs exist in the system. A corresponding edge 508 may then be generated based on the vertex 504 according to the static directed multigraph 506. For example, it is possible to generate all potential edges for a vertex, and such operation is done independently for each vertex, regardless of the size of the job, and thus it has the same time complexity of O(1).

The edge 508 may then be checked to see if it already exists in the dynamic directed multigraph 510. For example, if the same edge is detected to already exist, it indicates that there is a conflict; if no same edge is detected, it indicates that there is no conflict. Since each edge is unique and can be stored in the edge hash table, the time complexity of checking for conflicts is also O(1). If no conflict is detected, the edge 508 may be saved, and the dynamic directed multigraph 510 may be updated. Afterwards, the job 502 may be scheduled for execution. It should be understood that the vertex 504 corresponding to the job 502 is unique, but the number of the generated edges 508 may be one or more, depending on the conflict strategies defined in the static directed multigraph. Since the time complexity of the vertex search operation, the edge generation operation, and the edge checking operation is all O(1), the execution time of these operations is not affected by the number of jobs in the data protection system, so conflict detection can be efficient when processing new jobs.

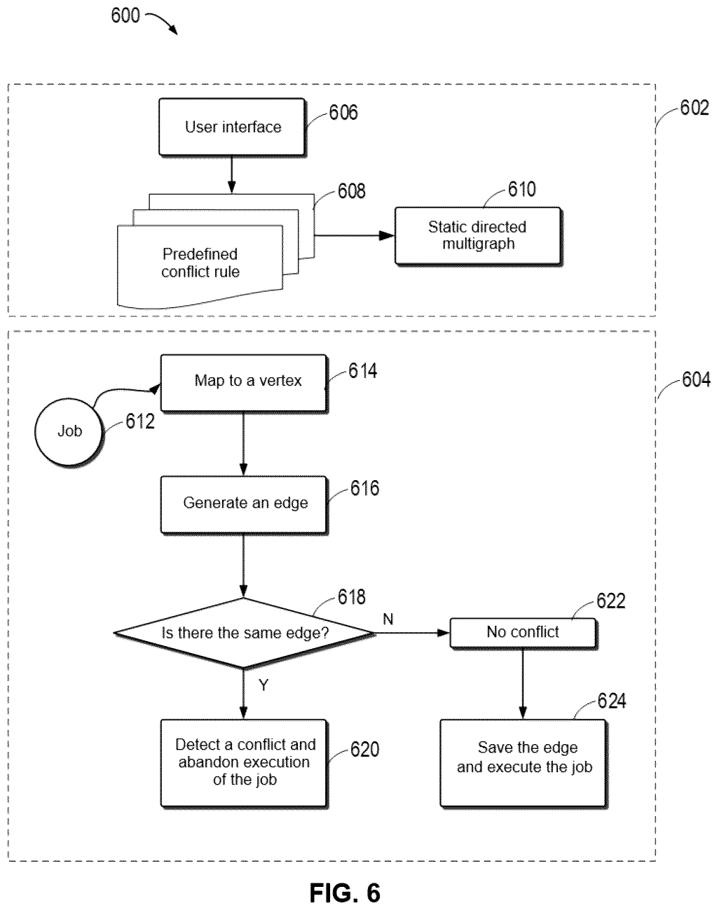

FIG. 6 shows a schematic diagram of a process 600A of job management in a data protection system according to an embodiment of the present disclosure. As shown in FIG. 6, the process 600 of job management may include an initialization process 602 and a conflict detection process 604. A static directed multigraph model can be initialized when the system starts. At this stage, only vertexes and edges associated with conflict strategies between vertexes are generated. For example, a user may operate a predefined conflict strategy 608 through a user interface 606, for example, the conflict strategy may be added, deleted, modified, and checked. A static directed multigraph 610 may then be generated based on the predefined conflict strategy 602. The initialization process 602 is a one-time initialization operation to ensure that the necessary static directed multigraph 610 is prepared prior to system operation.

While the system is running, whenever a new job comes in, the system performs the conflict detection process 604. For example, at block 614, when a job 612 enters the system, the job 612 may be mapped to a corresponding vertex. In some embodiments, a vertex corresponding to a job may be determined according to the job type of the job. For example, if the job type is “backup job,” the job can be mapped to a vertex that represents “backup job.” It should be understood that backup job here is for the purpose of illustration only and also applicable to different types of jobs, such as recovery job, data migration job, and so on.

At block 616, a corresponding edge may be generated in the dynamic directed multigraph according to a conflict strategy in the static directed multigraph 610. For example, a predefined rule in the static directed multigraph is used to determine a potential conflict between the new job and other job types, and the generated edge represents a potential conflict. At block 618, the generated edge may be checked to see whether it exists in the dynamic directed multigraph. If the generated edge already exists, it means that the resource has been occupied and the system needs to take measures to avoid the conflict, and it proceeds to block 620. At block 620, it may be determined that a conflict is detected and running the job 612 is abandoned. If a conflict is identified, the system will not execute the job, avoiding potential resource contention or system instability. For example, if two jobs attempt to use the same computing node simultaneously, the data protection system may choose to abandon subsequent jobs to ensure that the running jobs can be accomplished successfully.

At block 618, it proceeds to block 622 if the generated edge is not in a dynamic directed multigraph. At block 622, it may be determined that there is no conflict between the job 612 and the running jobs. At block 624, the generated edge may be saved, and the job 612 may be executed. In other words, it has been determined that there are no conflicts between jobs, so the new job can be safely scheduled and executed. The operation of saving the edge can update the dynamic directed multigraph so that it reflects the latest job operation.

In some embodiments, when a job is accomplished, the edges associated with the job may be removed from a dynamic directed multigraph. For example, when the job 612 is scheduled for execution, corresponding edges can be added to the dynamic directed multigraph, and when the execution of the job 612 has been accomplished, corresponding edges can be removed from the dynamic directed multigraph, so as to maintain the accuracy of the graph structure and ensure that the conflict detection of subsequent jobs can be performed correctly. Therefore, by initializing the directed multigraph model when the system starts, the system can quickly respond to the scheduling demands of new jobs, and dynamically update the graph structure after each job is accomplished, to ensure that conflicts between jobs can be detected and processed in a timely manner. This conflict detection mechanism based on graph structure improves the operational efficiency of the system and can reduce the risk caused by job conflicts.

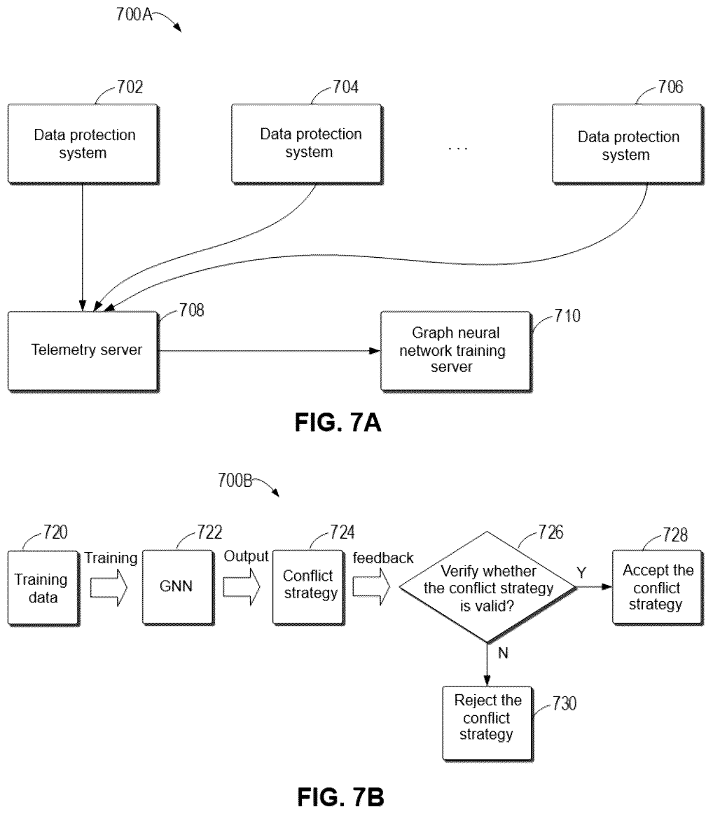

FIG. 7A shows a schematic diagram of a process 700A of collecting data to train a Graph Neural Network GNN according to an embodiment of the present disclosure. Due to the complexity of job conflicts and the possible limitations of predefined static directed multigraphs, some actual job conflicts may be overlooked. Thus, in some embodiments of the present disclosure, a GNN may be trained based on historical graph data to generate a new conflict strategy to update the static directed multigraph. As shown in FIG. 7A, a telemetry server 708 may collect graph snapshots and job failure information from a plurality of data protection systems (e.g., a data protection system 702, a data protection system 704, and a data protection system 706). It should be understood that data may be collected from more or fewer data protection systems. For example, when a job fails, a data protection system can take a snapshot of the current dynamic directed multigraph and collect information related to the failed job (for example, error logs). The graph snapshot and failed job information may be collected by the telemetry server 708 and used as training data.

The telemetry server 708 may transmit the collected training data to the GNN training server 710 for offline training. For example, the GNN training server 710 may be trained based on the collected data to identify potential conflict strategies. This training takes place in an offline environment, so there is no impact on the real-time performance of the data protection system. Therefore, GNN can be used to update the conflict strategy in the static directed multigraph to ensure that the system can identify conflicts that may have been previously overlooked in a timely manner, thereby improving the security and reliability of job scheduling. Next, the training process of GNN and its use to update the conflict strategy will be described in detail in conjunction with FIG. 7B.

FIG. 7B shows a schematic diagram of a process 700B of generating a conflict strategy based on a GNN and performing verification according to an embodiment of the present disclosure. At block 720, data for training may be collected. As described in FIG. 7A, the training data may include a graph snapshot at the time of job failure and the related failure information. For example, when a backup job fails on a specific host, the data protection system can record the current graph structure, the usage of related resources (such as host IDs, storage device IDs, and so on), and log information. These data are collected by the telemetry server and can be entered into the GNN as training data. At block 722, the GNN may conduct offline training based on the training data. Through multiple iterations of training, the GNN can identify potential conflict patterns and rules, and generate new conflict strategies. These generated rules may cover complex conflicts that have not been captured by the predefined static directed multigraph before. For example, the system may find that the concurrent execution of some jobs in a specific period of time will lead to conflicts, thus generating new rules to avoid this situation.

At block 724, the GNN may output a predicted conflict strategy. For example, the predicted conflict strategy may include the probability of conflict, as well as the related job types and attributes. For example, the GNN may output a predicted conflict strategy specifying that if two job types A and B access the same storage device at the same time, the probability of conflict is 80%. At block 726, it may be verified whether the conflict strategy generated by the GNN is valid. For example, an administrator can evaluate the reasonableness and feasibility of generated conflict strategies. For example, if a conflict strategy generated indicates that two particular jobs may conflict in certain circumstances, the administrator needs to confirm whether this conflict is really possible. It should be understood that verifying whether a rule is available by an administrator here is only an example, and the embodiments of the present disclosure do not limit the specific way of verification. If the generated conflict strategy is valid, the conflict strategy can be accepted at block 728, and the static directed multigraph will be updated. If the generated conflict strategy is not available, the conflict strategy can be rejected at block 730.

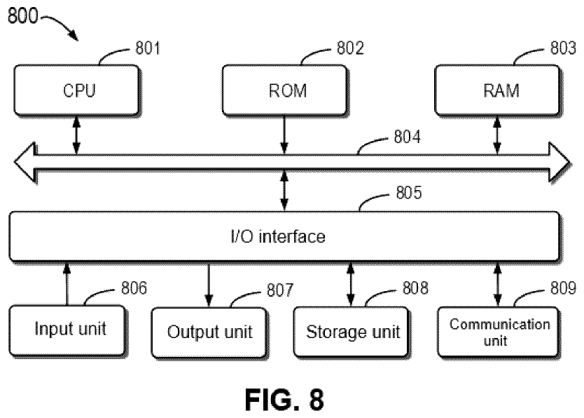

FIG. 8 shows a schematic block diagram of a device 800 that can be used to implement the embodiments of the present disclosure. The device 800 may be the device or apparatus described in the embodiments of the present disclosure. As shown in FIG. 8, the device 800 includes a central processing unit (CPU) 801, which may execute various appropriate actions and processing according to computer program instructions stored in a read-only memory (ROM) 802 or computer program instructions loaded onto a random access memory (RAM) 803 from a storage unit 808. Various programs and data required for the operation of the device 800 may also be stored in the RAM 803. The CPU 801, the ROM 802, and the RAM 803 are connected to each other through a bus 804. An input/output (I/O) interface 805 is also connected to the bus 804.

A plurality of components in the device 800 are connected to the I/O interface 805, including: an input unit 806, such as a keyboard and a mouse; an output unit 807, such as various types of displays and speakers; the storage unit 808, such as a magnetic disk and an optical disc; and a communication unit 809, such as a network card, a modem, and a wireless communication transceiver. The communication unit 809 allows the device 800 to exchange information/data with other devices via a computer network, such as the Internet, and/or various telecommunication networks.

The various methods or processes described above may be performed by the processing unit 801. For example, in some embodiments, the method may be implemented as a computer software program that is tangibly included in a machine-readable medium, such as the storage unit 808. In some embodiments, part or all of the computer program may be loaded and/or installed onto the device 800 via the ROM 802 and/or the communication unit 809. When the computer program is loaded onto the RAM 803 and executed by the CPU 801, one or more steps or actions of the methods or processes described above may be executed.

In some embodiments, the methods and processes described above may be implemented as a computer program product. The computer program product may include a computer-readable storage medium on which computer-readable program instructions for performing various aspects of the present disclosure are loaded.

The computer-readable storage medium may be a tangible device that may retain and store instructions used by an instruction-executing device. For example, the computer-readable storage medium may be, but is not limited to, an electrical storage device, a magnetic storage device, an optical storage device, an electromagnetic storage device, a semiconductor storage device, or any suitable combination thereof. More specific examples (a non-exhaustive list) of the computer-readable storage medium include: a portable computer disk, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices, or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The computer program instructions for performing the operations of the present disclosure may be assembly instructions, instruction set architecture (ISA) instructions, machine instructions, machine-related instructions, microcode, firmware instructions, status setting data, or source code or object code written in any combination of one or more programming languages, including object-oriented programming languages as well as conventional procedural programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer can be connected to a user computer through any kind of network, including a local area network (LAN) or a wide area network (WAN), or can be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions so as to implement various aspects of the present disclosure.

These computer-readable program instructions may be provided to a processing unit of a general-purpose computer, a special-purpose computer, or another programmable data processing apparatus to produce a machine, such that these instructions, when executed by the processing unit of the computer or another programmable data processing apparatus, generate an apparatus for implementing the functions/actions specified in one or more blocks in the flow charts and/or block diagrams. The computer-readable program instructions may also be stored in a computer-readable storage medium. These instructions cause a computer, a programmable data processing apparatus, and/or another device to operate in a particular manner, such that the computer-readable medium storing the instructions includes an article of manufacture which includes instructions for implementing various aspects of the functions/actions specified in one or more blocks in the flow charts and/or block diagrams.

The computer-readable program instructions can be loaded onto a computer, other programmable data processing apparatuses, or other devices, so that a series of operating steps are performed on the computer, other programmable data processing apparatuses, or other devices to produce a computer-implemented process. Therefore, the instructions executed on the computer, other programmable data processing apparatuses, or other devices implement the functions/actions specified in one or more blocks in the flow charts and/or block diagrams.

The flow charts and block diagrams in the accompanying drawings show the architectures, functions, and operations of possible implementations of the device, the method, and the computer program product according to a plurality of embodiments of the present disclosure. In this regard, each block in the flow charts or block diagrams may represent a module, a program segment, or part of an instruction, the module, program segment, or part of an instruction including one or more executable instructions for implementing specified logical functions. In some alternative implementations, the functions denoted in the blocks may also occur in an order different from that shown in the accompanying drawings. For example, two consecutive blocks may in fact be executed substantially concurrently, and sometimes they may also be executed in a reverse order, depending on the functions involved. It should be further noted that each block in the block diagrams and/or flow charts as well as a combination of blocks in the block diagrams and/or flow charts may be implemented by a dedicated hardware-based system executing specified functions or actions, or by a combination of a dedicated hardware and computer instructions.

The embodiments of the present disclosure have been described above. The above description is illustrative, rather than exhaustive, and is not limited to the disclosed various embodiments. Numerous modifications and alterations are apparent to persons of ordinary skill in the art without departing from the scope and spirit of the illustrated embodiments. The selection of terms as used herein is intended to best explain the principles and practical applications of the various embodiments or the technical improvements to technologies on the market, or to enable other persons of ordinary skill in the art to understand the embodiments disclosed herein.

1. A method for determining a job conflict, comprising:
determining, based on a job type of a target job, a target vertex corresponding to the target job in a dynamic graph, wherein the target job is associated with an operation in a data protection system, and the dynamic graph is generated based on a static graph identifying conflict strategies between different job types;
generating, based on the conflict strategies identified by the static graph, a target edge associated with the target vertex in the dynamic graph, wherein an edge in the dynamic graph corresponds to a running job in the data protection system; and
determining, in response to the target edge already existing in the dynamic graph, that a conflict exists between the target job and the running job.

2. The method according to claim 1, wherein generating the target edge associated with the target vertex in the dynamic graph comprises:
obtaining from the static graph a static edge with a starting point being the target vertex, wherein the static edge indicates a conflict strategy related to a job attribute of the target job; and
generating, based on the static edge and the job attribute of the target job, in the dynamic graph the target edge corresponding to the static edge, and the target edge having the same edge attribute as the job attribute.

3. The method according to claim 2, wherein the job attribute comprises at least one of a host used for executing the target job and an asset related to the target job.

4. The method according to claim 3, wherein determining in the dynamic graph the target vertex corresponding to the target job comprises:
determining a target vertex corresponding to the job type utilizing a vertex hash table, wherein a key in the vertex hash table is a job type, and a value in the vertex hash table is a vertex in the dynamic graph.

5. The method according to claim 3, wherein determining that a conflict exists between the target job and the running job comprises:
determining whether the target edge is in an edge hash table corresponding to the dynamic graph based on the starting point, end point, and edge attribute of the target edge, wherein the edge hash table stores all edges in the dynamic graph; and
determining, in response to the target edge existing in the edge hash table, that a conflict exists between the target job and the running job.

6. The method according to claim 5, further comprising:
determining, in response to the target edge not existing in the edge hash table, that no conflict exists between the target job and the running job;
scheduling the target job in the data protection system; and
adding the target edge to the dynamic graph.

7. The method according to claim 6, further comprising:
removing, in response to the target job being accomplished, the target edge from the dynamic graph.

8. The method according to claim 1, further comprising:
abandoning, in response to a conflict existing between the target job and the running job, execution of the target job.

9. The method according to claim 1, further comprising:
collecting training data for training a graph neural network from a plurality of data protection systems, wherein the training data comprises a snapshot of a dynamic graph and information on a failed job; and
training the graph neural network based on the training data.

10. The method according to claim 9, further comprising:
generating, based on the trained graph neural network, an updated edge in the static graph, the updated edge indicating an updated conflict strategy associated with the information on the failed job; and
adding, in response to the updated conflict strategy being valid, the updated edge to the static graph.

11. An electronic device, comprising:
a processor; and
a memory coupled to the processor and having instructions stored therein that, when executed by the processor, cause the processor to perform following actions:
determining, based on a job type of a target job, a target vertex corresponding to the target job in a dynamic graph, wherein the target job is associated with an operation in a data protection system, and the dynamic graph is generated based on a static graph identifying conflict strategies between different job types;
generating, based on the conflict strategies identified by the static graph, a target edge associated with the target vertex in the dynamic graph, wherein an edge in the dynamic graph corresponds to a running job in the data protection system; and
determining, in response to the target edge already existing in the dynamic graph, that a conflict exists between the target job and the running job.

12. The electronic device according to claim 11, wherein generating the target edge associated with the target vertex in the dynamic graph comprises:
obtaining from the static graph a static edge with a starting point being the target vertex, wherein the static edge indicates a conflict strategy related to a job attribute of the target job; and
generating, based on the static edge and the job attribute of the target job, in the dynamic graph the target edge corresponding to the static edge, and the target edge having the same edge attribute as the job attribute.

13. The electronic device according to claim 12, wherein the job attribute comprises at least one of a host used for executing the target job and an asset related to the target job.

14. The electronic device according to claim 13, wherein determining in the dynamic graph the target vertex corresponding to the target job comprises:
determining a target vertex corresponding to the job type utilizing a vertex hash table, wherein a key in the vertex hash table is a job type, and a value in the vertex hash table is a vertex in the dynamic graph.

15. The electronic device according to claim 13, wherein determining that a conflict exists between the target job and the running job comprises:
determining whether the target edge is in an edge hash table corresponding to the dynamic graph based on the starting point, end point, and edge attribute of the target edge, wherein the edge hash table stores all edges in the dynamic graph; and
determining, in response to the target edge existing in the edge hash table, that a conflict exists between the target job and the running job.

16. The electronic device according to claim 15, wherein the actions further comprise:
determining, in response to the target edge not existing in the edge hash table, that no conflict exists between the target job and the running job;
scheduling the target job in the data protection system; and
adding the target edge to the dynamic graph.

17. The electronic device according to claim 16, wherein the actions further comprise:
removing, in response to the target job being accomplished, the target edge from the dynamic graph.

18. The electronic device according to claim 11, wherein the actions further comprise:
abandoning, in response to a conflict existing between the target job and the running job, execution of the target job.

19. The electronic device according to claim 11, wherein the actions further comprise:
collecting training data for training a graph neural network from a plurality of data protection systems, wherein the training data comprises a snapshot of a dynamic graph and information on a failed job; and
training the graph neural network based on the training data.

20. A non-transitory computer-readable medium comprising machine-executable instructions that, when executed, cause a machine, cause the machine to perform following actions:
determining, based on a job type of a target job, a target vertex corresponding to the target job in a dynamic graph, wherein the target job is associated with an operation in a data protection system, and the dynamic graph is generated based on a static graph identifying conflict strategies between different job types;
generating, based on the conflict strategies identified by the static graph, a target edge associated with the target vertex in the dynamic graph, wherein an edge in the dynamic graph corresponds to a running job in the data protection system; and
determining, in response to the target edge already existing in the dynamic graph, that a conflict exists between the target job and the running job.
